(19) United States
(12) Patent Application Publication
(10) Pub. No.: US 2015/0195882 A1
(43) Pub. Date: Jul. 9, 2015

(54) SERIES CONTROL CIRCUIT AND CONTROL METHOD THEREOF

(71) Applicant: EOREX CORPORATION, HSINCHU COUNTY (TW)

(72) Inventor: CHIH-WEI CHU, HSINCHU COUNTY (TW)

(73) Assignee: EOREX CORPORATION, HSINCHU COUNTY (TW)

(21) Appl. No.: 14/259,477

(22) Filed: Apr. 23, 2014

(30) Foreign Application Priority Data
Jan. 8, 2014 (TW) 103100679

(51) Int. Cl. H05B 33/08; H04L 12/741

(52) U.S. Cl. CPC H05B 33/0845; H05B 33/0815; H04L 45/74

(57) ABSTRACT

A series control circuit is disclosed. The series control circuit comprises a master driving control module and N driving control modules. The master driving control module receiving an alternative current voltage is used for transmits a command packet via a data line according to a firmware, wherein the command packet comprises an identification code and a work instruction. The driving control module receives the command packet and determines whether a local address code is equal to the identification code. If the local address code is equal to the identification code, the driving control module transmits a driving signal to a designated driving channel. If the local address code is not equal to the identification code, the driving control module transmits the command packet to next driving control module.

### BACKGROUND OF THE INVENTION

1. Field of the Invention

The instant disclosure relates to a control circuit; in particular, to a series control circuit to drive light emitting diodes.

2. Description of Related Art

Light Emitting Diode (LED) is a solid semi-conductor component, emitting luminescence, having smaller volume, longer life-time, less power consumption, faster reacting rate, better shock resistance, etc. In recent years, LED light strings have been widely used for decorating trees, surroundings, windows, signboards or the walls of buildings, so as to give the decorated things a better look. LED is a special diode. When a forward bias voltage is applied, electrons and electron holes move within the semi-conductor film because of the potential difference resulted from the applied electric field, and further the recombination of electrons and electron holes is generated within the emitting layer. At this moment, the light-emitting molecules would be excited to the excited state by the power released because of the recombination, and reversely certain portion of energy would be emitted as light when the light-emitting molecules decay from the excited state to the ground state.

With the technology developed, LEDs having various colors can be made currently. The general used materials in the beginning of the development may be Gallium Arsenide (GaAs) and Aluminum Gallium Arsenide (AlGaAs) that can make LEDs emitting red light, Aluminum Gallium Phosphide(AlGaP) and Gallium Nitride (GaN) that can make LEDs emitting green light, and Zinc Selenide (ZnSe) and Silicon Carbide (SiC) that can make LEDs emitting blue light. The luminous intensity (brightness) of LEDs is mainly depended on the current flowing through the LEDs, wherein the brightness is in proportion to the current. In other words, as larger current flows through the LED, the brightness would be stronger, and reversely as smaller current flows through the LED, the brightness would be relatively weak.

However, in the prior art, the serial communications such as UART, SPI, I2C and so on are often used in the controller at the high (or mid-high) end, while they are usually removed in the controllers having lower cost, which forces the designer having rare resources to design a flexible communication having high-efficiency and costing least hardware resources. Regarding to board to board applications, considering the convenience during the back-end process and the cost, the amount of connecting lines should be decreased to reduce the manual working and wiring cost. Regarding to the power supply, the transformers would be used in the prior art to provide the work voltage, but the price thereof would build a huge increase of cost, weight and volume.

### SUMMARY OF THE INVENTION

The instant disclosure provides a series control circuit. The series control circuit comprises a master driving control module and N driving control modules. The master driving control module receives an AC voltage, and transmits a command packet according to a firmware and via a data line wherein the command packet comprises an identification code and a work instruction so as to determine a designated driving module and a designated driving channel respectively. Each of the N driving control modules has a local address code that is different from others. The driving control modules are connected with each other in series via a power line and a data line and sequentially divide a master input voltage outputted by the master driving control module. A first driving control module among the driving control modules is connected to the master driving control module via the power line and the data line so as to receive the master input voltage and the command packet, and a N^{th} driving control module among the driving control modules is connected to the master driving control module via the power line wherein N is a positive integer. A X^{th} driving control module among the driving control modules receives the command packet and determines whether the local address code is identical to the identification code according to the identification code. The X^{th} driving control module transmits a driving signal to the designated driving channel according to the work instruction if the local address code is identical to the identification code, and the X^{th} driving control module transmits the command packet to a (X+1)^{th} driving control module if the local address code is not identical to the identification code, wherein X is a positive integer between 1 and N.

In an embodiment of the instant disclosure, the command packet is coded via time intervals wherein each time interval is between two adjacent pulses among a plurality of pulses, and the X^{th} driving control module has an operator to calculate the time interval between two adjacent pulses when the X^{th} driving control module receives the command packet so as to decode the command packet.

In an embodiment of the instant disclosure, the operator is a counter or a timer.

In an embodiment of the instant disclosure, the driving control modules receive a work voltage respectively via the power line so as to provide power for each driving control module for operating.

In an embodiment of the instant disclosure, the X^{th} driving control module among the driving control modules comprises a X^{th} data pre-processing circuit, a X^{th} power supply circuit and a X^{th} slave controller. The X^{th} data pre-processing circuit is electrically connected to a (X−1)^{th} driving control module to receive the command packet and filter a DC component of the command packet. The X^{th} power supply circuit is electrically connected to a (X−1)^{th} power supply circuit to receive a (X−1)^{th} output voltage and output a X^{th} output voltage to a (X+1)^{th} power supply circuit. Also, the X^{th} power supply circuit is configured to provide the work voltage wherein the X^{th} output voltage is larger than the (X−1)^{th} output voltage. The X^{th} slave controller has the local address code and is electrically connected to the X^{th} data pre-processing circuit and a (X+1)^{th} data pre-processing circuit. The X^{th} slave controller decodes the command packet via the operator so as to capture the identification code and the work instruction from the command packet.

In an embodiment of the instant disclosure, the X^{th} slave controller determines whether the local address code is identical to the identification code according to the identification code. The X^{th} slave controller transmits the driving signal to the designated driving channel according to the work instruction if the local address code is identical to the identification code.

In an embodiment of the instant disclosure, the X^{th} data pre-processing circuit comprises a X^{th} capacitor. The X^{th} capacitor is electrically connected to the (X−1)^{th} slave controller and the X^{th} slave controller. The X^{th} capacitor is configured to block a DC component of the series pulse signals, transforms each of the series pulse signals into a positive and negative pulse signal and transmits the positive and negative pulse signal to the X^{th} slave controller.

The X^{th} slave controller determines whether a positive peak value of the positive and negative pulse signal is larger than a first threshold voltage and whether a negative peak value of the positive and negative pulse signal is smaller then a second threshold voltage when the X^{th} slave controller receives the positive and negative pulse signal, wherein the first threshold voltage is larger than the second threshold voltage.

In an embodiment of the instant disclosure, if the X^{th} slave controller determines that a positive peak value of the positive and negative pulse signal is larger than a first threshold voltage and that a negative peak value of the positive and negative pulse signal is smaller than a second threshold voltage, the X^{th} slave controller calculates to sequentially decode the command packet via the operator.

In an embodiment of the instant disclosure, the X^{th} power supply circuit is configured to provide the work voltage to the X^{th} slave controller. The X^{th} power supply circuit comprises a X^{th} resistor and a X^{th} zener diode. The X^{th} resistor has one terminal electrically connected to an output end of a (X−1)^{th} power supply circuit to receive the (X−1)ₜₕ output voltage and has another terminal electrically connected to the X^{th} slave controller. The X^{th} zener diode has anode electrically connected to another terminal of the X^{th} resistor and has cathode transmitting the X^{th} output voltage to an input end of a (X+1)^{th} power supply circuit and the X^{th} slave controller. The X^{th} zener diode is configured to divide the (X−1)^{th} output voltage.

In an embodiment of the instant disclosure, the master driving control module comprises a buck circuit, a bridge rectifying circuit, a front-end power supply circuit and a master controller. The buck circuit is electrically connected to the AC voltage. The bridge rectifying circuit is electrically connected to the buck circuit and the Nth driving control module, and the bridge rectifying circuit is configured to rectify and filter the AC voltage via a filter capacitor so as to output a DC voltage. The front-end power supply circuit is electrically connected to the bridge rectifying circuit via the power line to receive the DC voltage. The front-end power supply circuit reduces the DC voltage to the master input voltage so as to provide the master input voltage to the first driving control module among the driving control modules. The master controller is electrically connected to the front-end control circuit and the first driving control module, and the master controller is configured to determine the designated driving module and the designated driving channel according to the firmware. Also, the master controller transmits the command packet to the first driving control module via the data line.

In an embodiment of the instant disclosure, the master controller uses time intervals to code the command packet wherein each time interval is between two adjacent pulses among a plurality of pulses, and the front-end power supply circuit provides a work voltage to the master controller.

The instant disclosure provides a control method used in a series control circuit. The series control circuit comprises a master driving control module and N driving control modules. The master driving control module receives an AC voltage and transmits a command packet according to a firmware and via a data line, wherein the command packet comprises an identification code and a work instruction so as to determine a designated driving module and a designated driving channel respectively. Each driving control module has a local address code that is different from others. The driving control modules are connected with each other in series via a power line and a data line and sequentially divide a master input voltage outputted by the master driving control module. A first driving control module among the driving control modules is connected to the master driving control module via the power line and the data line so as to receive the master input voltage and the command packet, and a N^{th} driving control module among the driving control modules is connected to the master driving control module via the power line. The control method comprises: receiving the command packet via a X^{th} driving control module among the driving control modules; decoding the command packet via a X^{th} driving control module among the driving control modules; capturing the identification code and the work instruction from the command packet via a X^{th} driving control module among the driving control modules; determining whether the local address code is identical to the identification code according to the identification code; transmitting a driving signal to the designated driving channel according to the work instruction by the X^{th} driving control module if the local address code is identical to the identification code; and transmitting the command packet to a (X+1)^{th} driving control module by the X^{th} driving control module if the local address code is not identical to the identification code. Particularly, N is a positive integer between 1 and N.

To sum up, the series control circuit and the control method thereof provided by the instant disclosure can transmit a stable electrical power merely via one power line and can transmit the command packet for data transmitting merely via one data line. Accordingly, the instant disclosure can reduce the number of connecting lines between boards and can also decrease the cost on manual working and wires.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a series control circuit according to an embodiment of the instant disclosure;

FIG. 2 shows a flow chart of a control method of a series control circuit according to an embodiment of the instant disclosure;

FIG. 3 shows a detailed circuit diagram of a series control circuit according to another embodiment of the instant disclosure;

FIG. 4 shows a schematic diagram of coding command packet according to an embodiment of the instant disclosure; and

FIG. 5 shows a schematic diagram of identifying command packet according to an embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

The instant disclosure provides a series control circuit to drive a plurality of LED strings to have various display effects. The instant disclosure uses a simple circuit to transform the AC power supply into a DC power supply so as to provide power to a plurality of Micro Control Units (MCU), of which uses the least connecting lines between boards and a simple signal transmission crossing logical levels. In other words, the series control circuit provides electrical power to each driving control module via one power line and transmits data to the designated driving module and the designated driving channel via one data line for successfully controlling.

The following instruction is to describe a series control circuit and a control method thereof via a plurality of embodiments with corresponding drawings. However, the embodiments below are not for restricting the scope of the instant disclosure.

[One embodiment of a series control circuit]

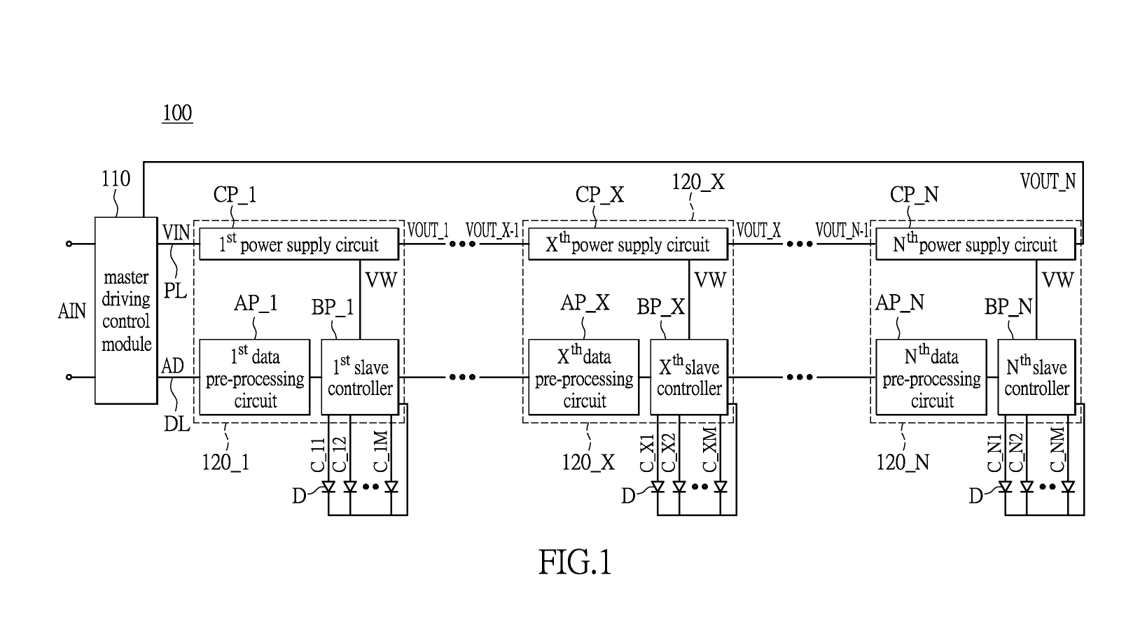

Please refer to FIG. 1, FIG. 1 shows a block diagram of a series control circuit according to an embodiment of the instant disclosure. As shown in FIG. 1, the series control circuit 100 comprises a master driving control module 110 and N driving control modules 120_1˜120_N, wherein N is a positive integer. In the present embodiment, the master driving control module 110 receives an AC voltage AIN as the power source of the series control circuit 100. The master driving control module 110 transmits a command packet AD according to a firmware and via a data line DL wherein the command packet AD comprises an identification code and a work instruction. The identification code is to determine one of the driving control modules 120_1˜120_N as a designated driving module, and the work instruction is to determine a designated driving channel. A first driving control module 120_1 among a plurality of driving control modules 120_1˜120 N is electrically connected to the master driving control module 110 via a power line PL and a data line DL so as to receive a master input voltage VIN and the command packet AD respectively. The N^{th} driving control module 120_N among a plurality of driving control modules 120_1˜120_N is electrically connected to the master driving control module 110 via the power line PL. It should be noticed that, in the instant disclosure, each of N driving control modules 120_1˜120_N has a local address code that is different from others, and a plurality of driving control modules 120_1˜120_N are connected with each other in series via the power line PL and the data line DL and sequentially divide the master input voltage VIN wherein the identification code is to distinguish the different address codes of a plurality of driving control modules 120_1˜120_N. Moreover, in one embodiment, there's at least one channel that the driving control module drives so the driving control module can drive the channel that the driving control module tends to drive according to the work instruction. Therefore, the designer can define the local address code, the identification code and the work instruction onto a firmware depending on actual needs. In the present embodiment, a plurality of driving control modules 120_1˜120_N receive work voltages respectively via the power line PL so as to acquire the needed power for operating. A plurality of driving control modules 120_1˜120_N have functions of dividing voltage and regulating voltage, and respectively transmits output voltages VOUT_1˜VOUT_N to the next circuit block, as shown in FIG. 1.

In the series control circuit 100 provided by the instant disclosure, the X^{th} driving control module 120_X among the driving control modules 120_1˜120_N receives the command packet AD, and the X^{th} driving control module 120_X determines whether the local address code is identical to the identification code according to the identification code. The X^{th} driving control module 120_X further transmits a driving signal to the designated driving channel according to the work instruction so as to execute the working content of the work instruction if the local address code of the X^{th} driving control module 120_X is identical to the identification code. On the other hand, the X^{th} driving control module 120_X transmits the command packet AD to the (X+1)^{th} driving control module 120_X+1 (that is, the next driving control module) if the local address code of the X^{th} driving control module 120_X is not identical to the identification code, wherein X is a positive integer between 1 and N. It is worth mentioning that, in the instant disclosure, the command packet AD is coded with time intervals wherein each time interval is between two adjacent pulses among a plurality of pulses, and the X^{th} driving control module 120_X has at least one operator to calculate the time interval between two adjacent pulses when the X^{th} driving control module 120_X receives the command packet AD, so as to decode the command packet AD such that the X^{th} driving control module 120_X can capture the identification code and the work instruction. It is worth mentioning that, in one embodiment, the operator may be a timer or a counter.

In the following description is further instruction in teaching a work mechanism of the series control circuit 100. Before further instruction, is it clarified that, the driving control module 120_1 is electrically connected to a plurality of driving channels C_11˜C_1M and the driving control module 120_N is electrically connected to a plurality of driving channels C_11˜C_NM, wherein M is a positive integer greater than 1, there is one diode D in each channel (in the present embodiment, the diode D is a Light Emitting Diode) and the number of the diodes is not limited thereto.

Regarding to the power supply, the master driving control module 110 first rectifies and filters the AC voltage AIN and then outputs a master input voltage VIN via the power line PL to the first driving control module 120_1 after the master driving control module 110 receives the AC voltage AIN. In the present embodiment, a plurality of driving control modules 120_1˜120_N have functions of dividing voltage and regulating voltage, so the first driving control module 120_1 divides the master input voltage VIN and provides an output voltage VOUT_1 to the second driving control module 120_2, and similarly, the N^{th} driving control module 120 N receives the output voltage VOUT_N−1 and provides the VOUT_N to the master driving control module 110.

Regarding to the data transmission, the master driving control module 110 transmits the command packet AD via the data line DL to the first driving control module 120_1 according to the program in the firmware. The first driving control module 120_1 calculates the time interval between two adjacent pulses via the operator when the first driving control module 120_1 receives the command packet AD, so as to decode the command packet AD and capture the identification code and the work instruction from the command packet AD. After that, the first driving control module 120_1 determines whether its local address code is identical to the identification code. The first driving control module 120_1 further transmits a driving signal to the designated driving channel to drive the diode D of the designated driving channel and stop transmitting the command packet AD to the next driving control module (that is, the second driving control module 120_2) according to the work instruction if its local address code is identical to the identification code, wherein the designated driving channel is at least one of the driving channels C_11˜C_1M. On the other hand, the first driving control module 120_1 transmits the command packet AD to the next driving control module (that is, the second driving control module 120_2) if its local address code is not identical to the identification code. Likewise, the X^{th} driving control module 120_X repeats the working mechanism described above after the X^{th} driving control module 120_X receives the command pocket, so as to drive the diode D of the designated driving channel.

For a specific instruction on an operation process of the series control circuit 100 of the instant disclosure, there is at least one of the embodiments for further instruction.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

Another Embodiment of a Series Control Circuit

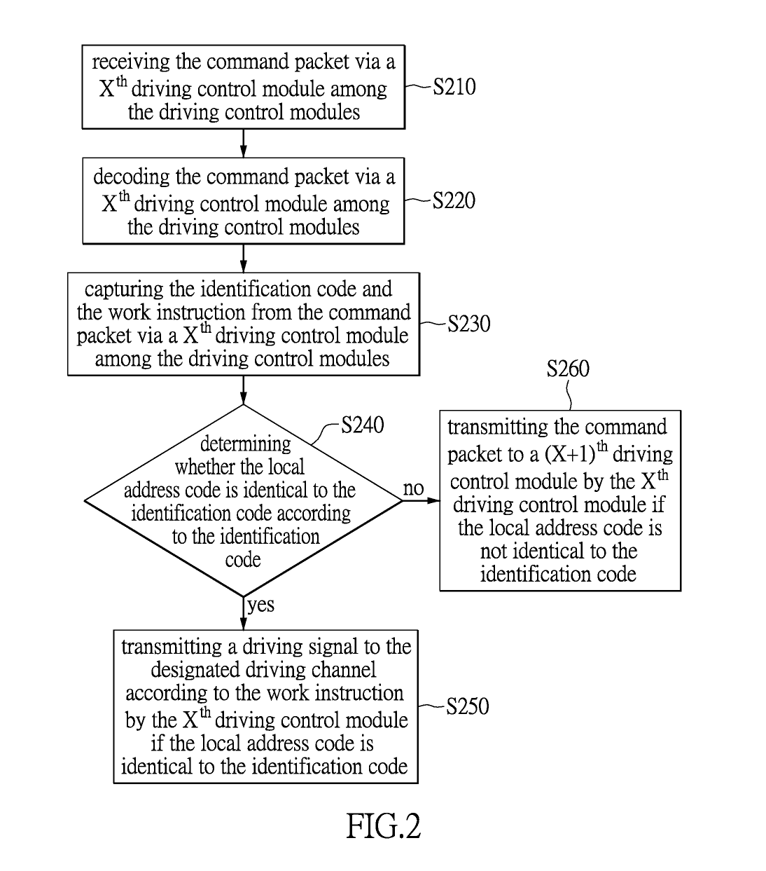

In conjunction with FIG. 1 and FIG. 2, FIG. 2 shows a flow chart of a control method of a series control circuit according to an embodiment of the instant disclosure. The control method of the series control circuit 100 comprises steps as below: receiving the command packet AD via a X ^{th} driving control module 120_X among a plurality of driving control modules 120_1˜120_N (Step S210); decoding the command packet AD via a X^{th} driving control module 120_X among a plurality of driving control modules 120_1˜120_N (Step S220); capturing the identification code and the work instruction from the command packet AD via a X^{th} driving control module 120_X among a plurality of driving control modules 120_1˜120_N (Step S230); determining whether the local address code is identical to the identification code according to the identification code (Step S240); transmitting a driving signal to the designated driving channel according to the work instruction by the X^{th} driving control module 120_X if the local address code is identical to the identification code (Step S250); and transmitting the command packet AD to a (X+1)^{th} driving control module 120_X+1 by the X^{th} driving control module 120_X if the local address code is not identical to the identification code (Step S260). Relevant details of the steps of the control method regarding the series control circuit 100 are described in the embodiments of FIG. 1, and thus it is not repeated thereto. It is clarified that, a sequence of steps in FIG. 2 is set for a need to instruct easily, and thus the sequence of the steps is not used as a condition in demonstrating the embodiments of the instant disclosure.

Moreover, different from the embodiment shown in FIG. 1, in the present embodiment, the X^{th} driving control module 120_X comprises a X^{th} data pre-processing circuit AP_X, a X^{th} power supply circuit CP_X and a X^{th} slave controller BP_X, wherein X is a positive integer between 1 and N. For example, the first driving control module 120_1 comprises a first data pre-processing circuit AP_1, a first power supply circuit CP_1 and a first slave controller BP_1, and similarly, the N^{th} driving control module 120 N comprises a N^{th} data pre-processing circuit AP_N, a N^{th} power supply circuit CP_N and a N^{th} slave controller BP N. The X^{th} data pre-processing circuit 120_X is electrically connected to the (X−1)^{th} driving control module 120_X−1. The X^{th} data pre-processing circuit 120_X receives the command packet AD and filters the DC component of the command packet AD, wherein the X^{th} data pre-processing circuit 120_X may be a capacitive circuit. The X^{th} power supply circuit CP_X is electrically connected to the (X−1)^{th} power supply circuit CP_X−1 in the last driving control module 120₁₃ X−1 so as to receive the (X−1)^{th} output voltage VOUT_X−1 and output the X^{th} output voltage VOUT_X to the (X+1)^{th} power supply circuit CP_X+1 in the next driving control module 120_X+1. The X^{th} power supply circuit CP_X is configured to provide a work voltage VW to the X^{th} slave controller BP_X wherein the X^{th} output voltage VOUT_X+1 is larger than the (X−1)^{th} output voltage VOUT_X−1. The X^{th} slave controller BP_X has a local address code and an operator. The X^{th} slave controller BP_X is electrically connected to the X^{th} data pre-processing circuit AP_X and the (X+1)^{th} data pre-processing circuit AP_X+1 in the (X+1)^{th} driving control module BP_X+1. The X^{th} slave controller BP_X calculates time intervals via the operator to decode the command packet AD and capture the identification code and the work instruction from the command packet AD, wherein each time interval is between two adjacent pulses among a plurality of pulses and the command packet AD is coded with these time intervals.

In the instant disclosure, the X^{th} slave controller BP_X receives and decodes the command packet AD and captures the identification code and the work instruction from the command packet AD. Afterwards, the X^{th} slave controller BP_X determines whether its local address code is identical to the identification code according to the identification code. The X^{th} slave controller BP_X further transmits the driving signal to the designated driving channel (at least one of the driving channels C_X1˜C_XM) according to the work instruction if its local address code is identical to the identification code, so as to execute the working content of the work instruction. On the other hand, the X^{th} slave controller BP_X transmits the command packet AD to the (X+1)^{th} data pre-processing circuit AP_X+1 in the next driving control module 120_X+1 if its local address code is not identical to the identification code.

In a further instruction, regarding to the power supply, the master driving control module 110 first rectifies and filters the AC voltage AIN and outputs a master input voltage VIN via the power line PL to the first power supply circuit in the first driving control module 120_1 after the master driving control module 110 receives the AC voltage AIN. In the present embodiment, a plurality of power supply circuits CP_1˜CP₁₃ N all have functions of dividing voltage and regulating voltage, so the first power supply circuit CP_1 divides the master input voltage VIN and provides a first output voltage VOUT_1 to the power supply circuit CP_2, wherein the first power supply circuit CP_1 transmits a work voltage VW to the first slave controller BP_1 so as to provide the needed electrical power. Similarly, the N^{th} power supply circuit CP_N receives the output voltage VOUT_N−1 and transmits the output voltage VOUT_N and the work voltage VW respectively to the master driving control module 110 and the N^{th} slave controller BP_N.

Regarding to the data transmission, the master driving control module 110 transmits the command packet AD via the data line DL to the first data pre-processing circuit AP_1 in the first driving control module 120_1 according to a program in the firmware. The first data pre-processing circuit AP_1 receives the first data pre-processing circuit AP_1 and pre-processes it, that is, the first data pre-processing circuit AP_1 filters the DC component and leaves the AC component of the command packet AD, wherein the first data pre-processing circuit AP_1 may be a capacitive circuit that can block the DC component. After that, the first data pre-processing circuit AP_1 transmits the processed command packet AD to the first slave controller BP_1. The first slave controller BP_1 calculates time intervals via the operator, wherein each time interval is between two adjacent pulses, when the first slave controller BP_1 receives the command packet AD, so as to decode the command packet AD and capture the identification code and the work instruction from the command packet AD. Afterwards, the first slave controller BP 1 determines whether its local address code is identical to the identification code. The first slave controller BP_1 further transmits a driving signal to the designated driving channel to drive the diode D of the designated driving channel and stop transmitting the command packet AD to the next driving control module (that is, the second driving control module 120_2) according to the work instruction if its local address code is identical to the identification code, wherein the designated driving channel is at least one of the driving channels C_11˜C_1M. On the other hand, the first slave controller BP_1 transmits the command packet AD to the next driving control module (that is, the second data pre-processing circuit AP_2 of the second driving control module 120_2) if its local address code is not identical to the identification code. Similarly, after the X^{th} data pre-processing circuit AP_X receives the command packet AD, the X^{th} data pre-processing circuit AP_X and the X^{th} slave controller BP_X repeats the working mechanism described above so as to drive the diode D of the designated driving channel. Additionally, the ground ends of a plurality of the driving control modules 120_1˜120_N are all different.

Therefore, the series control circuit 100 provided by the instant disclosure can sequentially transmit data to the designated driving module and the designated driving channel via the working mechanism described above. It is worth mentioning that, the command packet in the instant disclosure is coded with time intervals wherein each time interval is between two adjacent pulses among a plurality of pulses and can be decoded via the operator of the driving control module wherein the operator may be a timer or a counter. Accordingly, the instant disclosure can control the connection in series between boards merely via one power line and one data line, which can dramatically reduce the amount of connecting lines used in the series control circuit 100. In practice, a plurality of driving control modules 120_1˜120_N are respectively configured on the slave control board and the master driving control module 110 is configured on the master control board.

For a specific instruction on an operation process of the series control circuit 100 of the instant disclosure, there is at least one of the embodiments for further instruction.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

Still Another Embodiment of a Series Control Circuit

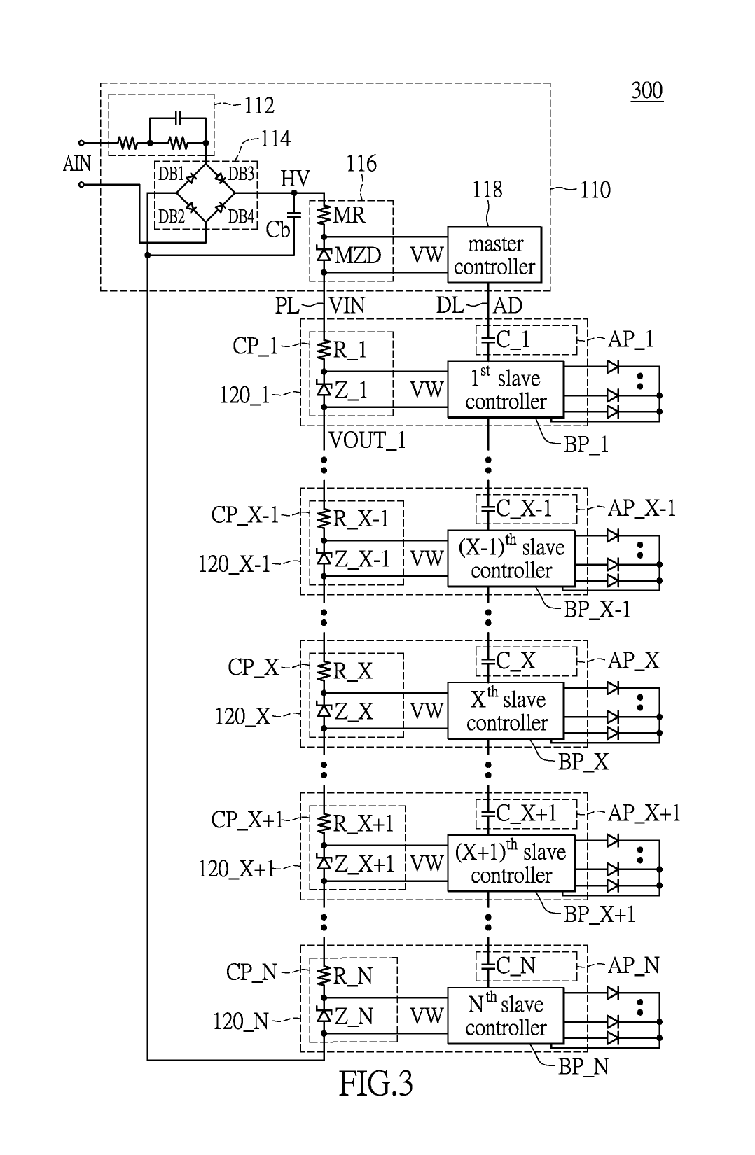

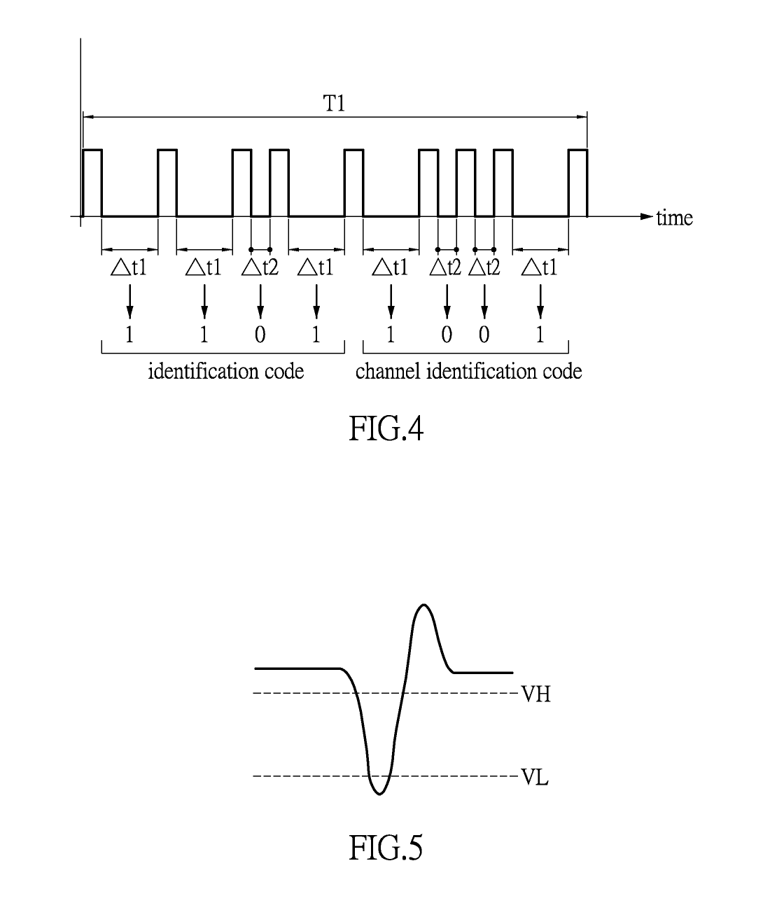

Please in conjunction with FIG. 3, FIG. 4 and FIG. 5, FIG. 3 shows a detailed circuit diagram of a series control circuit according to another embodiment of the instant disclosure, FIG. 4 shows a schematic diagram of coding command packet according to an embodiment of the instant disclosure and FIG. 5 shows a schematic diagram of identifying command packet according to an embodiment of the instant disclosure. Before proceeding instruction, it is to be clarified that, the embodiment is taken an example of the command packet with eight bits to instruct, but the instant disclosure is not limited thereto. People skilled in the arts may be able to make adjustment depending on needs, which are within a scope of the instant disclosure. Moreover, for an easy instruction and understanding of the instant disclosure, merely an instruction period T1 is shown in FIG. 4 for an example, and it is not limited thereto. After that, different from the embodiment shown in FIG. 1, I regarding to the series control circuit 300 in the present embodiment, the X^{th} data pre-processing circuit AP_X comprises the X^{th} capacitor C_X. The X^{th} capacitor C_X is electrically connected to the (X−1)^{th} slave controller BP_X−1 and the X^{th} slave controller BP_X+1. The X^{th} power supply circuit CP_X comprises a X^{th} resistor R_X and a X^{th} zener diode Z_X. One terminal of the X^{th} resistor R_X is electrically connected to the output end of the (X−1)^{th} power supply circuit CP_X−1 so as to receive the (X−1)^{th} output voltage VOUT_X−1. Another terminal of the X^{th} resistor R_X is electrically connected to the X^{th} slave controller BP_X. Anode of the X^{th} zener diode Z_X is electrically connected to another terminal of the X^{th} resistor R_X. Cathode of the X^{th} zener diode Z_X transmits the X^{th} output voltage VOUT_X to the input end of the (X+1)^{th} power supply circuit CP_X+1 and the X^{th} slave controller BP_X. The master driving control module 110 comprises a buck circuit 112, a bridge rectifying circuit 114, a front-end power supply circuit 116 and a master controller 118. The buck circuit 112 is electrically connected to the AC voltage AIN. The bridge rectifying circuit 114 is electrically connected to the buck circuit 112 and the N^{th} driving control module 120 N. The master controller 118 is electrically connected to the front-end power supply circuit 116 and the first capacitor C_1 of the first driving control module 120_1. The front-end power supply circuit 116 is electrically connected to the bridge rectifying circuit 114 via the power line PL so as to receive the DC voltage HV. The front-end power supply circuit 116 comprises a front-end resistor MR and a front-end zener diode MZD, wherein one terminal of the front-end resistor MR is electrically connected to the DC voltage HV and another terminal of the front-end resistor MR is electrically connected to anode of the front-end zener diode MZD. Cathode of the front-end zener diode MZD outputs the master input voltage VIN.

In one embodiment, the bridge rectifying circuit 114 comprises diodes DB1˜DB4 wherein anode and cathode of the diode DB1 are respectively connected to anode of the diode DB3 and anode of the diode DB2, and anode and cathode of the diode DB4 are respectively connected to cathode of the diode DB3 and cathode of the diode DB2. In addition, the master driving control module 110 comprises a filter capacitor Cb. One terminal of the filter capacitor Cb is electrically connected to anode of the diode DB3 and another terminal of the filter capacitor Cb is electrically connected to anode of the diode DB2.

The X^{th} capacitor C_X is to block the DC component of the series pulse signal so as to realize the function of capacitor that can block the DC component and all ground ends of the slave controllers BP_1˜BP_X are different, so the problems regarding to the floating potential can be conquered via the capacitors C_1˜C_N. In a further instruction, the X^{th} capacitor C_X transforms each of pulse signals into a positive and negative pulse signal (as shown in FIG. 5) and transmits the positive and negative pulse signals to the X^{th} slave controller BP_X so that the X^{th} slave controller BP_X can make an identification. The X^{th} slave controller BP_X determines whether a positive peak value of the positive and negative pulse signal is greater than the first threshold voltage VH and whether a negative peak value of the positive and negative pulse signal is smaller than the second threshold voltage VL when the X^{th} slave controller BP_X receives the positive and negative pulse signal, wherein the first threshold voltage VH is greater than the second threshold voltage VL. After that, via the operator (such as, a timer or a counter), the X^{th} slave controller BP_X calculates time intervals and each of the time intervals is between two adjacent pulses (such as, the first pulse time interval Δt1 or the second pulse time interval Δt2) if the X^{th} slave controller BP_X determines that a positive peak value of the positive and negative pulse signal is greater than the first threshold voltage VH and that a negative peak value of the positive and negative pulse signal is smaller than the second threshold voltage VL, so as to sequentially decode the command packet AD, wherein the first pulse time interval Δt1 and the second pulse time interval Δt2 are different. In the present embodiment, the identification code (having four bits) is a digital signal “1101” and the work instruction (having four bits) is a digital signal “1001”, of which the number of bits can be adjusted depending on the actual needs for circuits so it is not limited thereto.

In the present embodiment, the X^{th} zener diode Z_X is configured to regulate voltage, the X^{th} resistor R_X and the X^{th} zener diode Z_X are configured to divide the (X−1)^{th} output voltage VOUT and provide a work voltage VW to the X^{th} slave controller BP_X. For example, the resistor R_1 and the first zener diode Z_1 are configured to divide the master input voltage VIN and provide a work voltage VW to the first slave controller BP_1, and the second resistor R_2 and the second zener diode Z_2 are configured to divide the output voltage VOUT_1 and provide a work voltage VW to the second slave controller BP_2. In a further instruction, a plurality of resistors R_1˜R_N in series and a plurality of zener diodes Z_1˜Z_N in series can gradually divide the master input voltage VIN, and the series control circuit 300 provided by the present embodiment can regulate the work voltage VW via the zener diodes Z_1˜Z_N. Moreover, in the present embodiment, the bridge rectifying circuit 114 rectifies the AC voltage AIN to output a DC voltage HV via the filter capacitor Cb. The DC voltage HV is divided and regulated via the front-end resistor MR and the front-end zener diode MZD, and then reduced to the master input voltage VIN. For a further instruction, the front-end power supply circuit 116 (that is, the front-end resistor MR and the front-end zener diode MZD) is configured to reduce the DC voltage to the master input voltage VIN so as to provide the master input voltage VIN to the first power supply circuit CP_1 of the first first driving control module 120_1 among a plurality of driving control modules 120_1˜120_N, and also the front-end power supply circuit 116 provides a work voltage VW to the master controller 118. Afterwards, the master controller 118 is configured to determine the designated driving module and the designated driving channel according to the firmware, and also the the master controller 118 transmits the command packet AD via the data line DL to the first capacitor C_1 of the first data pre-processing circuit AP_1 so as to pre-process for the data transmission. In the present embodiment, the master controller 118 uses the first pulse time interval Δt1 and the second pulse time interval Δt2 among a plurality of pulse signals (as shown in FIG. 4) to code the command packet AD that is to be transmitted.

It should be notice that, in the present embodiment, the first pulse time interval Δt1 is defined as the digital logic “1” and the second pulse time interval Δt2 is defined as the digital logic “0”, but it is not limited thereto. Further, the command packet AD in the instant disclosure is coded with a plurality of pulse waveforms, which reduces the influence on the differentiating circuit resulted from the coding with the pulse width modulated signals in the prior art.

To sum up, the series control circuit and the control method thereof provided by the instant disclosure can transmit a stable electrical power merely via one power line and can transmit the command packet for data transmitting merely via one data line. Accordingly, the instant disclosure can reduce the number of connecting lines between boards and can also decrease the cost on manual working and wires.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A series control circuit, comprising:
a master driving control module, receiving an AC voltage, and transmitting a command packet according to a firmware and via a data line wherein the command packet comprises an identification code and a work instruction so as to determine a designated driving module and a designated driving channel respectively; and
N driving control modules, each driving control module having a local address code that is different from others, the driving control modules connected with each other in series via a power line and the data line and sequentially dividing a master input voltage outputted by the master driving control module, a first driving control module among the driving control modules connected to the master driving control module via the power line and the data line so as to receive the master input voltage and the command packet, and a N^{th} driving control module among the driving control modules connected to the master driving control module via the power line wherein N is a positive integer;
wherein a X^{th} driving control module among the driving control modules receives the command packet and determines whether the local address code is identical to the identification code according to the identification code, if the local address code is identical to the identification code and the X^{th} driving control module transmits a driving signal to the designated driving channel according to the work instruction, and if the local address code is not identical to the identification code and the X^{th} driving control module transmits the command packet to a (X+1)^{th} driving control module wherein the X is a positive integer between 1 and N.

2. The series control circuit according to claim 1, wherein the command packet is coded via time intervals between two adjacent pulses among a plurality of pulses, and the X^{th} driving control module has an operator to calculate the time interval between two adjacent pulses when the X^{th} driving control module receives the command packet so as to decode the command packet.

3. The series control circuit according to claim 2, wherein the operator is a counter or a timer.

4. The series control circuit according to claim 1, wherein the driving control modules receive a work voltage respectively via the power line so as to provide power for each driving control module for operating.

5. The series control circuit according to claim 2, wherein the X^{th} driving control module among the driving control modules comprises:
a X^{th} data pre-processing circuit, electrically connected to a (X−1)^{th} driving control module to receive the command packet and filter a DC component of the command packet;
a X^{th} power supply circuit, electrically connected to a (X−1)^{th} power supply circuit to receive a (X−1)^{th} output voltage and output a X^{th} output voltage to a (X+1)^{th} power supply circuit, and the X^{th} power supply circuit configured to provide the work voltage wherein the X^{th} output voltage is larger than the (X−1)^{th} output voltage; and
a X^{th} slave controller, having the local address code, the X^{th} slave controller electrically connected to the X^{th} data pre-processing circuit and a (X+1)^{th} data pre-processing circuit, and the X^{th} slave controller decoding the command packet via the operator so as to capture the identification code and the work instruction from the command packet.

6. The series control circuit according to claim 5, wherein the X^{th} slave controller determines whether the local address code is identical to the identification code according to the identification code, if the local address code is identical to the identification code and the X^{th} slave controller transmits the driving signal to the designated driving channel according to the work instruction, and if the local address code is not identical to the identification code and the X^{th} slave controller transmits the command packet to a (X+1)^{th} data pre-processing circuit.

7. The series control circuit according to claim 5, wherein the X^{th} data pre-processing circuit comprises:
a X^{th} capacitor, electrically connected to the (X−1)^{th} slave controller and the X^{th} slave controller, the X^{th} capacitor configured to block a DC component of the series pulse signals, transforms each of the series pulse signals into a positive and negative pulse signal and transmits the positive and negative pulse signal to the X^{th} slave controller;
wherein the X^{th} slave controller determines whether a positive peak value of the positive and negative pulse signal is larger than a first threshold voltage and whether a negative peak value of the positive and negative pulse signal is smaller then a second threshold voltage when the X^{th} slave controller receives the positive and negative pulse signal, wherein the first threshold voltage is larger than the second threshold voltage.

8. The series control circuit according to claim 7, wherein the X^{th} slave controller calculates to sequentially decode the command packet via the operator if the X^{th} slave controller determines that a positive peak value of the positive and negative pulse signal is larger than a first threshold voltage and that a negative peak value of the positive and negative pulse signal is smaller than a second threshold voltage.

9. The series control circuit according to claim 5, wherein the X^{th} power supply circuit is configured to provide the work voltage to the X^{th} slave controller, and the X^{th} power supply circuit comprises:
a X^{th} resistor, having one terminal electrically connected to an output end of a (X−1)^{th} power supply circuit to receive the (X−1)^{th} output voltage and another terminal electrically connected to the X^{th} slave controller; and
a X^{th} zener diode, having anode electrically connected to another terminal of the X^{th} resistor and having cathode transmitting the X^{th} output voltage to an input end of a (X+1)^{th} power supply circuit and the X^{th} slave controller, and the X^{th} zener diode configured to divide the (X−1)^{th} output voltage.

10. The series control circuit according to claim 1, wherein the master driving control module comprises:
a buck circuit, electrically connected to the AC voltage;
a bridge rectifying circuit, electrically connected to the buck circuit and the N^{th} driving control module, the bridge rectifying circuit configured to rectify and filter the AC voltage via a filter capacitor so as to output a DC voltage;
a front-end power supply circuit, electrically connected to the bridge rectifying circuit via the power line to receive the DC voltage, the front-end power supply circuit reducing the DC voltage to the master input voltage so as to provide the master input voltage to the first driving control module among the driving control modules; and
a master controller, electrically connected to the front-end control circuit and the first driving control module, the master controller configured to determine the designated driving module and the designated driving channel according to the firmware, and the master controller transmitting the command packet to the first driving control module via the data line.

11. The series control circuit according to claim 10, wherein the master controller uses time intervals between two adjacent pulses among a plurality of pulses to code the command packet, and the front-end power supply circuit provides a work voltage to the master controller.

12. A control method, used in a series control circuit, the series control circuit comprising a master driving control module and N driving control modules, the master driving control module receiving an AC voltage, and transmitting a command packet according to a firmware and via a data line wherein the command packet comprises an identification code and a work instruction so as to determine a designated driving module and a designated driving channel respectively, each driving control module having a local address code that is different from others, the driving control modules connected with each other in series via a power line and the data line and sequentially dividing a master input voltage outputted by the master driving control module, a first driving control module among the driving control modules connected to the master driving control module via the power line and the data line so as to receive the master input voltage and the command packet, and a N^{th} driving control module among the driving control modules connected to the master driving control module via the power line, and the control method comprising:
receiving the command packet via a X^{th} driving control module among the driving control modules;
decoding the command packet via a X^{th} driving control module among the driving control modules;
capturing the identification code and the work instruction from the command packet via a X^{th} driving control module among the driving control modules;
determining whether the local address code is identical to the identification code according to the identification code;
transmitting a driving signal to the designated driving channel according to the work instruction by the X^{th} driving control module if the local address code is identical to the identification code; and
transmitting the command packet to a (X+1)^{th} driving control module by the X^{th} driving control module if the local address code is not identical to the identification code;
wherein N is a positive integer and between 1 and N.

13. The control method according to claim 12, wherein the command packet is coded via time intervals between two adjacent pulses among a plurality of pulses, and the X^{th} driving control module has an operator to calculate the time interval between two adjacent pulses when the X^{th} driving control module receives the command packet so as to decode the command packet.

14. The control method according to claim 13, wherein the operator is a counter or a timer.

15. The control method according to claim 13, wherein the driving control modules receive a work voltage respectively via the power line so as to provide power for each driving control module for operating.

16. The control method according to claim 14, wherein the X^{th} driving control module among the driving control modules comprises:
a X^{th} data pre-processing circuit, electrically connected to a (X−1)^{th} driving control module to receive the command packet and filter a DC component of the command packet;
a X^{th} power supply circuit, electrically connected to a (X−1)^{th} power supply circuit to receive a (X−1)^{th} output voltage and output a X^{th} output voltage to a (X+1)^{th} power supply circuit, and the X^{th} power supply circuit configured to provide the work voltage wherein the X^{th} output voltage is larger than the (X−1)^{th} output voltage; and
a Xth slave controller, having the local address code, the Xth slave controller electrically connected to the Xth data pre-processing circuit and a (X+1)th data pre-processing circuit, and the Xth slave controller decoding the command packet via the operator so as to capture the identification code and the work instruction from the command packet.

17. The control method according to claim 16, wherein the X^{th} slave controller determines whether the local address code is identical to the identification code according to the identification code, if the local address code is identical to the identification code and the X^{th} slave controller transmits the driving signal to the designated driving channel according to the work instruction, and if the local address code is not identical to the identification code and the X^{th} slave controller transmits the command packet to a (X+1)^{th} data pre-processing circuit.

18. The control method according to claim 16, wherein the X^{th} data pre-processing circuit comprises:
a X^{th} capacitor, electrically connected to the (X−1)^{th} slave controller and the X^{th} slave controller, the X^{th} capacitor configured to block a DC component of the series pulse signals, transforms each of the series pulse signals into a positive and negative pulse signal and transmits the positive and negative pulse signal to the X^{th} slave controller;
wherein the Xth slave controller determines whether a positive peak value of the positive and negative pulse signal is larger than a first threshold voltage and whether a negative peak value of the positive and negative pulse signal is smaller then a second threshold voltage when the X^{th} slave controller receives the positive and negative pulse signal, wherein the first threshold voltage is larger than the second threshold voltage.

19. The control method according to claim 18, wherein the X^{th} slave controller calculates sequentially decode the command packet via the operator if the X^{th} slave controller determines that a positive peak value of the positive and negative pulse signal is larger than a first threshold voltage and that a negative peak value of the positive and negative pulse signal is smaller than a second threshold voltage.

20. The control method according to claim 16, wherein the X^{th} power supply circuit is configured to provide the work voltage to the X^{th} slave controller, and the X^{th} power supply circuit comprises:
a X^{th} resistor, having one terminal electrically connected to an output end of a (X−1)^{th} power supply circuit to receive the (X−1)^{th} output voltage and another terminal electrically connected to the X^{th} slave controller; and
a Xth zener diode, having anode electrically connected to another terminal of the Xth resistor and having cathode transmitting the Xth output voltage to an input end of a (X+1)th power supply circuit and the Xth slave controller, and the Xth zener diode configured to divide the (X−1)th output voltage.

21. The control method according to claim 12, wherein the master driving control module comprises:
a buck circuit, electrically connected to the AC voltage;
a bridge rectifying circuit, electrically connected to the buck circuit and the N^{th} driving control module, the bridge rectifying circuit configured to rectify and filter the AC voltage via a filter capacitor so as to output a DC voltage;
a front-end power supply circuit, electrically connected to the bridge rectifying circuit via the power line to receive the DC voltage, the front-end power supply circuit reducing the DC voltage to the master input voltage so as to provide the master input voltage to the first driving control module among the driving control modules; and
a master controller, electrically connected to the front-end control circuit and the first driving control module, the master controller configured to determine the designated driving module and the designated driving channel according to the firmware, and the master controller transmitting the command packet to the first driving control module via the data line.

22. The control method according to claim 21, wherein the master controller uses time intervals between two adjacent pulses among a plurality of pulses to code the command packet, and the front-end power supply circuit provides a work voltage to the master controller.
